(19) United States
(12) Patent Application Publication
(10) Pub. No.: US 2014/0238012 A1
(43) Pub. Date: Aug. 28, 2014

(54) Stirling Engine

(71) Applicant: Solar Miller, Reno, NV (US)

(72) Inventor: Solar Miller, Reno, NV (US)

(21) Appl. No.: 13/411,630

(22) Filed: May 2, 2012

(51) Int. Cl. F02G 1/043

(52) U.S. Cl. CPC F02G 1/043
USPC 60/517

(57) ABSTRACT

A double acting, miller cycle, reciprocating piston with dual rotary displacer, stirling engine is provided. Configurable as a heat pump, a heat engine, or as a combination with one side driving the other, the engine is completely enclosed, sealed and pressurized with the piston ring as the only internal seal. A miller cycle is created by allowing transfer of the working fluid (typically hydrogen gas) past the piston to balance working fluid pressure only at the extremes of the piston stroke. Two coordinated rotating displacers service opposite sides of one piston. Each displacer manages heat flow, according to its length and shape, through one side of the length of its encasing tube into and out of the working fluid through the other side of the length of its encasing tube. The dead space between the piston and the displacer holds regenerator material.

### BACKGROUND

The concept of mechanically manipulating the ideal gas laws to convert heat into motion or vice-versa was first patented by Robert Stirling in 1817. Since that time several designs, most utilizing multiple pistons, have emerged including some designs utilizing pressure waves in lieu of a displacer with only a single piston.

The basic Stirling engine includes a trapped gas that is heated or cooled which then expands or contracts (according to the ideal gas laws) which pushes or pulls on a piston which then drives a crankshaft. The crankshaft is typically coupled to a flywheel and an output shaft. The output shaft delivers usable mechanical force relative to the initial temperature differential and amount of heat transferred.

Current commercial designs utilize a piston style displacer to move the working gas from a heating chamber to a cooling chamber and back. Common designs use multiple internal seals and two or more pistons. Current designs are complex and difficult to manufacture making them relatively high cost. The greater efficiency, reliability, lifespan, cleanliness, and flexibility that Stirling engines demonstrate compared to internal combustion engines has previously been sacrificed in favor of the faster start up, control response, greater power density, and ease of manufacture of competing engines. However, the inherent advantages of the Stirling engine allows it to compete successfully in various specialty niches of the engine market, such as satellite power production, waste heat recovery, cryogenics, solar power conversion, space craft, and submarines, where faster start up, control response, greater power density, and ease of manufacture are not the critical criteria in engine selection.

The Stirling engine has many advantages such that it could displace internal combustion engines in many applications if a few of the Stirling engine's drawbacks could be addressed. For example the Stirling engine has fewer moving parts, no need for expensive sound deadening or exhaust gas treatment, nor complex ignition, timing, and fuel handling requirements. Furthermore, the Stirling engine benefits from a large menu of energy sources and fuels to choose from and the use of non-polluting gasses when used in refrigeration.

Accordingly, there is a need for a Stirling engine with lower cost, and higher power density. Such an improved Stirling engine could become the mainstream choice in such applications as hybrid automobiles, aircraft, and boats, as well as electric generators, refrigerators and water heaters. In other words, applications in which costs, simplicity and power density are the primary consideration and where start up speed and control response are ancillary considerations.

### BRIEF DESCRIPTION OF THE DRAWINGS

The accompanying drawings, which are incorporated in and constitute a part of this specification, illustrate embodiments of an improved Stirling engine and together with the description, serve to explain the principles and operation thereof.

FIG. 1 is a hidden line perspective view of a Stirling engine according to an exemplary embodiment;

FIG. 2 is a hidden line end view of the Stirling engine shown in FIG. 1;

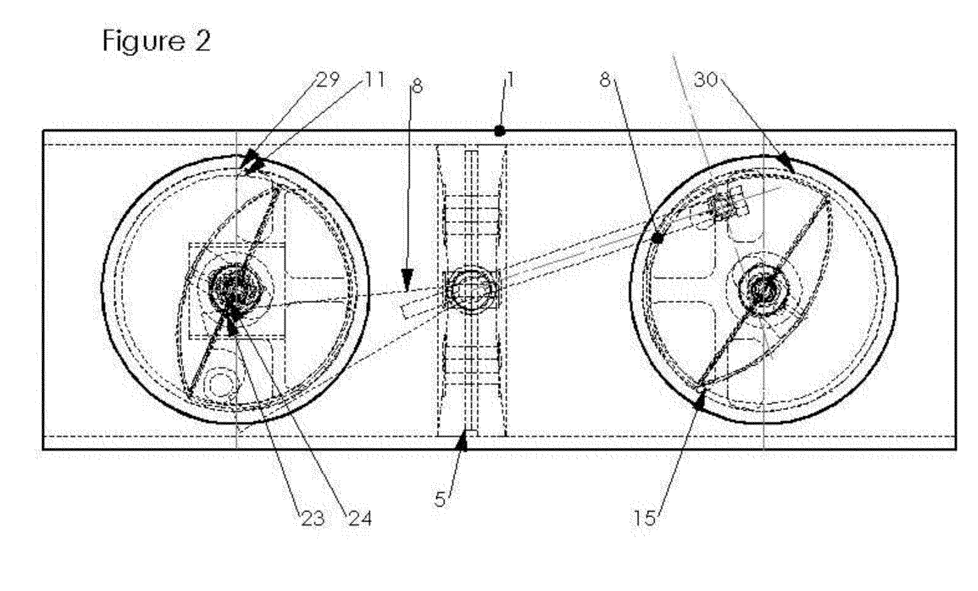

FIG. 3 is a multi-view representation of the Stirling engine shown in FIGS. 1 and 2;

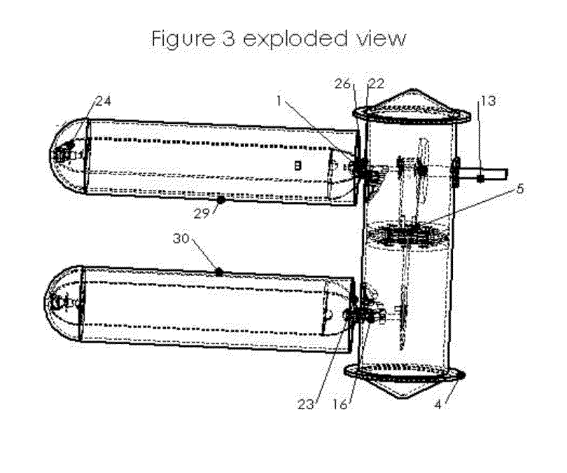

FIG. 4 is a transparent solid model perspective view of the Stirling engine shown in FIGS. 1-3;

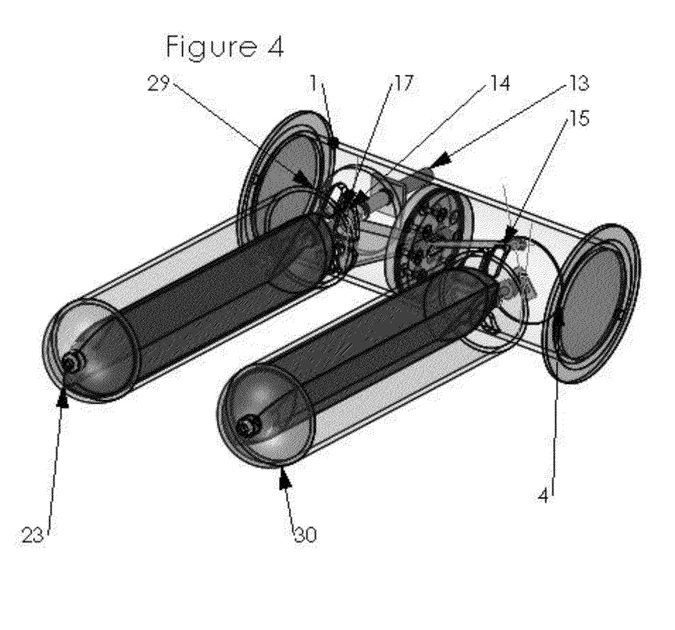

FIG. 5 is a transparent exploded solid model representation of the Stirling engine shown in FIG. 4;

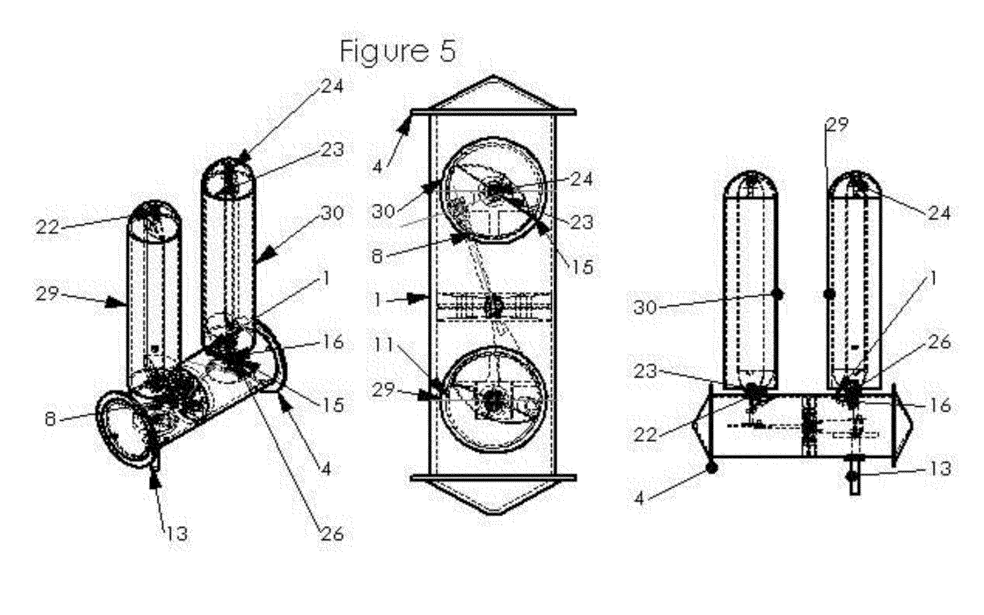

FIG. 6 is a transparent solid model end view of the Stirling engine shown in FIGS. 4 and 5 as viewed from the displacers; and

FIG. 7 is a transparent solid model end view of the Stirling engine shown in FIGS. 4-6 as viewed from the piston.

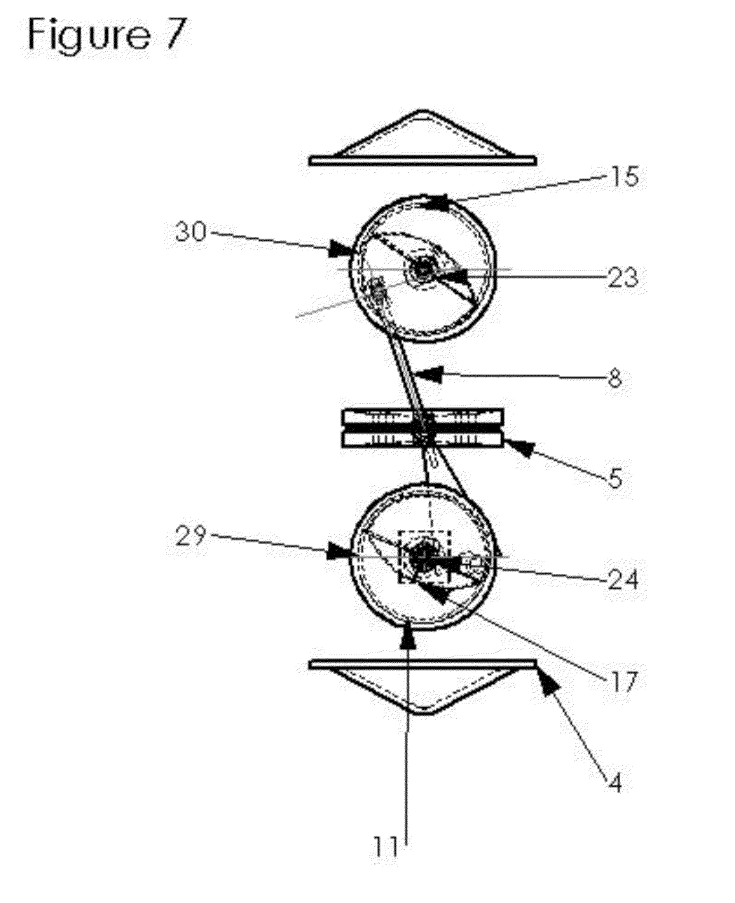

### DETAILED DESCRIPTION

| ITEM NO. | PART NUMBER |
|---|---|
| 1 | Cylinder single 8 |
| 2 | Cylinder bearing mount plate |
| 3 | Cylinder bearing internal support |
| 4 | Cylinder Chinese Hat |
| 5 | Piston 2part |
| 6 | Piston Pin 2 |
| 7 | Bearing 20 × 26 × 20 |
| 8 | Connect rod single v 2 top |
| 9 | Piston Pin displacer only side |
| 10 | nut .25 in |
| 11 | Crankshaft powerside |
| 12 | Bearing 10-26-8 |
| 13 | crankshaft half in ext |
| 14 | Screw flat head 1 4th in |
| 15 | Crankshaft thin open derived |
| 16 | Crank to Displacer rod |
| 17 | DriveShaft to crank clip |
| 18 | Bearing 8 id-12-3w |
| 19 | Washer 10-15-0325 |
| 20 | Washer 12-20-1 32nd |
| 21 | Pipe Intersect 5-6 |
| 22 | Bearing .5 × 1 × .344 |
| 23 | Displacer 9 |
| 24 | Heat Ex Cap Bearing Mount |
| 25 | Nut .5 × 15 mm |
| 26 | mate round hex |
| 27 | Heated tube 5.047 mate flange |
| 28 | Heated Tube Endcap 5.047 id |
| 29 | Copy of Heated Tube |
| 30 | Copy (4) of Heated Tube\hat{ }Cylinder and piston |
| 31 | Part2 |
| 32 | Radiator inside |
| 33 | Part4 |
| 34 | Part5 |
| 35 | Heating tube brace |
| 36 | Heating tube |
| 37 | HX-SHCS 0.5-20 × 3.5 × 2 − N |

Provided herein is an improved Stirling engine that addresses the difficulties and maximizes the advantages of the Stirling cycle engine. Lower production and maintenance costs are possible due to the elimination of all but one internal seal (on the piston) sealing all moving parts within the pressure vessel (isolating them from heat and corrosive gasses or liquids) and fewer, simpler parts manufactured with less precision.

Greater power density is achieved by using two displacers with one on either side of the piston to produce power in each direction of every stroke similar to the Stanley steamer engine. Working gas is transferred at the end of the power stroke, similar to the Miller cycle engine, to prevent counter pressure, pre-load the coming power stroke, and simplify initial pressurization. Greater initial pressurization, possible due to the elimination of external seals, makes more gas molecules available to transfer heat.

Smoother quieter operation is achieved with a lighter flywheel by means of reshaping and rotating rather than reciprocating the displacer. Using a single piston with both sides driven reduces complexity, compared to multiple cylinder engines of similar power output.

Rotating instead of reciprocating the displacer eliminates the counter action of gas pressure on the displacer piston during the power stroke as well as the extra friction. The working gas is guided into a vortex that efficiently transfers heat between the exchanger wall and the working gas. Adjusting the relative position of the displacer and the piston allows flexibility in where the heating and cooling areas are on the heat exchanger housing.

Rotating at 90 degrees to the piston, unless connected through a constant velocity joint or powered by separate motor or timing belt, the displacer provides precise control over the heating and cooling of the working gas. The displacer may be formed of a lightweight, insulating, and heat resistant, inflexible compound of either graphite carbon or silicon. The displacer may be coated with a pattern of insulator such as Aerogel and regenerator material (such as nickel foam) to appropriately guide heat flow and have a shape that creates and controls the turbulence of the working gas.

Working gas turbulence is controlled both by the cam shape of the displacer which compresses and releases the working gas in the desired direction and place, and by the shape of the chamber it creates as it directs the gas movement out of and into the piston cylinder. The working gas can be trapped in the displacer for a few degrees and released suddenly by creating a rotating valve at the intersection of the displacer and piston cylinder, for greater power. In an embodiment, a constantly rotating vortex is formed as the displacer turns and the working gas expands and contracts. In another embodiment, further control of turbulence may be achieved by placing storage pockets in the displacer that will pressurize during the heating cycle and release the pressure in a specific direction through a nozzle during the cooling cycle. The displacer shape and relative motion creates a constant sized area in which a mechanical means of directing turbulence, such as a fan, can be inserted if desired.

Greater heat input and therefore power as well as reduced complexity is made possible through utilizing the entire length of the displacer housing as opposed to heating only one end of the housing as in current designs (a wider path allows more heat to flow). More efficient heat transfer is achieved by means of greater control of working gas turbulence, optimization of the displacer chamber volume to surface ratio, shape, surface roughness and corrugation, direct control of heat transfer from heat source, adjustable displacer to piston ratio and minimization of dead space. The passage between the displacer and the piston may be filled with a mesh of nickel foam that acts as a re-generator.

The use of a through-the-piston connecting rod creates accurately timed coordination and counter rotation of the opposing displacer. In addition to eliminating possible frozen states on start up, the counter rotation of the displacers, with the flywheel turning opposite the direction of the output shaft, reduces gyroscopic progression that may be an issue in some applications. In most applications putting the flywheel on the output shaft will reduce total weight. Some configurations may disallow the use of a one piece through the piston connecting rod and require either two standard mirror image connecting rods or a timing belt or electronic means of coordinating the rotation of the two displacers. Since the displacers regulate and time the heat transfer from the exchanger to the working gas which then pushes on the piston, as long as the displacers are coordinated, no mechanical connection is required between the piston and displacers. A constant speed can be obtained by turning the displacers electronically to control the piston and crankshaft.

The piston is designed as a two identical piece part that is bolted together and houses a piston pin on bearings and provides for easy assembly of two opposing continuous oil-less piston rings. The concave shape of the piston face provides clearance for the crankshaft, strength for the power stroke and brings the displacers closer together without additional mechanical parts. Controlled leakage at the extreme of the piston stroke, similar to the Miller cycle, eliminates counter pressure when pressure is left over from the power stoke.

The piston cylinder doubles as the crankshaft housing and provides the fulcrum against which the crankshaft pushes. Since the entire engine is a pressure vessel, containing it within standard tubing reduces weight and complexity. The openings from the cylinder to the displacer chamber are shaped to minimize the loss of support against the pressure while providing adequate gas flow. Dead space is minimized by filling it with packing material to displace the gas. The bearing mounts are the same distance apart as the length of the connecting rod, measured from bearing center to bearing center on the connecting rod and the cylinder. Maintenance free bearings are located well away and shielded from heat sources for maximum maintenance free life. The lack of lubricating fluid eliminates the oil pump, tubing, machined channels oil filter and lightens the engine.

The displacer housing functions as the heat exchanger. Essentially a long tube, strong enough to contain the pressure while heated on one side and cooled on the other it has a welded cap at one end and is bolted or welded to the piston cylinder at the other end. While the points of assembly are shown in the figures as flanges, a high pressure model would use a stronger means of joining the pieces such as an interrupted thread design similar to a cannon breach, or a threaded pipe design or welding.

A rough finish and possibly corrugation interleaving with the displacer, to facilitate heat transfer, may be applied by chemical or mechanical means. When used with combustible fuels the heated side can be coated with catalyst to maximize the chemical reaction of the fuel with the oxidizer. The ideal material would be pure carbon in crystal form with a nano-scale fractal pattern finish to facilitate heat transfer from the source through the wall and into the working gas. Less ideal but still functional materials would be titanium or commercial steel tubing. Greater efficiency can be gained by constructing the displacer housing in a multi-part clam shell design separating the sides with insulation so the heat travels through the working gas instead of circumferentially through the shell. This may increase manufacturing costs; however, with the extended life span of the Stirling engine, the added efficiency of this option may be desired.

On the outside of the engine, the improvements include controlling and directing the heat from whatever source directly to the desired area on the exchanger with no need of the commonly used heater assembly. The use of insulation and ducting would be tailored to the heat source. The heat source may be geothermal, solar, combustion, or other desired heat source. The radiator, if used in home or business power generation may double as a water heater. The supporting structure of the engine and intake and exhaust would simplify the stacking and use of multiple engines to achieve higher required output. Waste heat from the radiator and the combustion products can partially be recycled to preheat air when combustible fuels are used. When using combustible fuels, the combustion area can be optimized for maximum efficiency depending upon the fuel used. Materials are chosen to optimize recycling of engines after their useful life. Maintenance is simplified with standard fasteners and bearings that are widely available. Standard tubing sizes and common piston sizes are purposely chosen, to simplify any repairs that may be needed in rural areas as well as reduce production costs. The entire engine is considered to be a pressure vessel, but the extra weight is minimal considering the greater power density achieved, that all moving parts are safely hidden inside and protected from dust and moisture, and the elimination of all but one external dynamic seal around the output shaft.

In an embodiment one side of the engine is powered and the other side is used as a heat pump for refrigeration or heating. While shown parallel and equal in the figures, the displacer tubes are independent of each other and multiple configurations are possible. For example, one heat exchanger could sit on the top of an insulated container and draw heat out of it forming a refrigerator. The heat would then be used to preheat the combustion process for the other heat exchanger which would drive the system. Alternatively, one engine could use fuel to drive a second engine that was used as a heat pump to provide refrigeration of food or medicine or distillation of liquids such as drinking water. Distillation would use both the heated and cooled sides of either or both of the exchangers.

In the event of catastrophic failure due to external insult or internal defect, the high-pressure gas is released in a controlled manner by the use of materials that deform rather than break. The route of pressure relief at the end of piston travel clears the working gas from the undamaged side of the engine in a controlled manner. The radiator also functions as a shrapnel catcher on the top while shrapnel directed downward is slowed by the heating duct work and directed by installation design into the earth or a component of the installation and away from sensitive areas. If Hydrogen is used as the working gas, mixing it with nitrogen or carbon dioxide should moderate the tendency to burn rapidly.

Also, contemplated herein are methods for providing rotational power according to the present disclosure. The methods thus encompass the steps inherent in the above described mechanical structures and operation thereof. Broadly, one method could include heating a volume of working gas with a heat source, directing the heated working gas to act on a piston, and rotating at least one displacer to displace the working gas away from the heat source such that the volume of working gas may be cooled.

Accordingly, the improved Stirling engine has been described with some degree of particularity directed to the exemplary embodiments. It should be appreciated, though, that modifications or changes may be made to the exemplary embodiments without departing from the inventive concepts contained herein.

What I claim as my invention is:

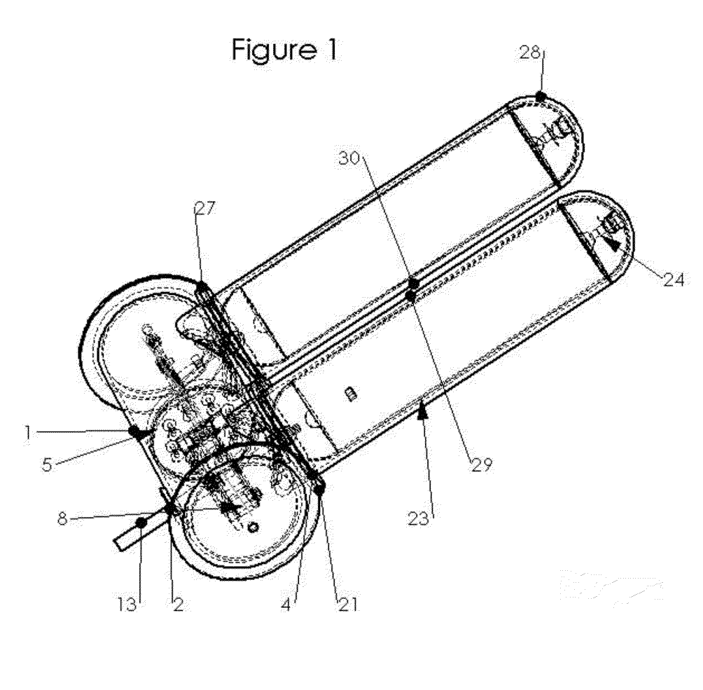

1. A double acting stifling engine in which a working fluid exerts force against a reciprocating piston comprising:
an elongated cylindrical heat exchanger connected at right angle, through regenerator material, to the piston cylinder with an elongated rotating displacer, of such mass as to serve as a flywheel, inside said heat exchanger, coordinated with said piston, that moves said working fluid from the heat input side, at which time said working fluid expands and exerts an increase of force on said piston, to the heat extraction side, where said working fluid contracts and reduces the pressure exerted upon said piston, thus completing one cycle while a similar though not necessarily identical heat exchanger and displacer perform the same sequence against the second side of said piston 180 degrees out of phase such that each direction of said piston is productive with said parts arranged according to FIG. 1.

2. A device as in claim 1 wherein a valve is actuated by the angle of the piston rod allowing the working fluid pressure to equalize across the piston at the extremes of the stroke of said piston.

3. A device as in claim 1 wherein there is only one displacer and heat exchanger and the engine is single acting.

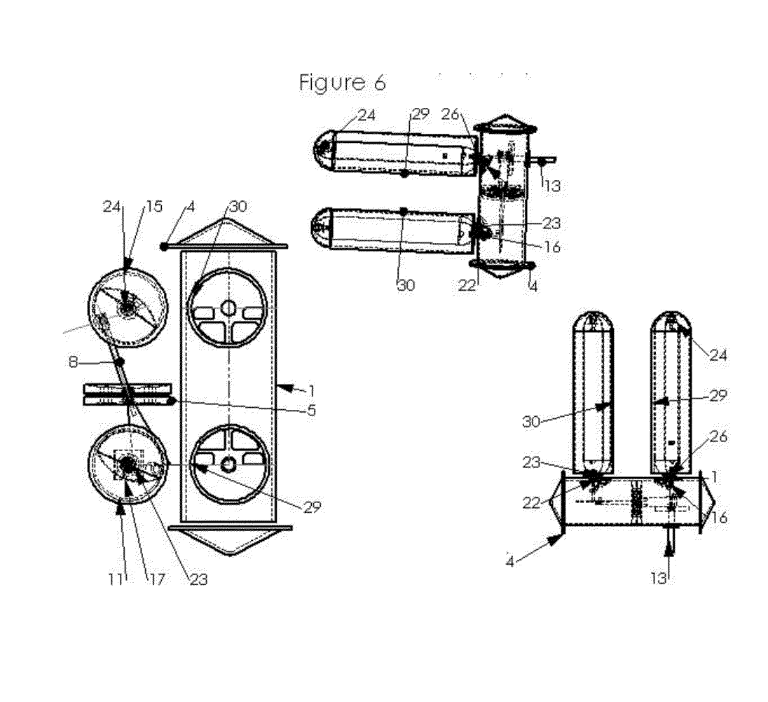

4. A device as in claim 2 wherein the displacer is comprised of one half lengthwise of one cylinder and a smaller division of a second cylinder of a larger radius divided along its length on a chord of length less than or equal to the diameter of the first half cylinder such that when the displacer is mounted in its heat exchanger their exists a gap for the working fluid to fill of the desired moon shape on one half of the radius of the displacer between the displacer and the heat exchanger wall for the working length of the displacer, as illustrated in FIG. 6.

5. A device as in claim 4 wherein the displacer is comprised of one half lengthwise of a cylinder and a separate cylinder of larger diameter divided lengthwise along a chord in which said chord of said larger cylinder is less than or equal to the diameter of the first smaller cylinder diameter.

6. A device as in claim 1 wherein the displacer is cylindrical and the working surface is along the length of said cylinder and the shape of the end closest to the piston directs the flow of working fluid in a desired manner.

7. A device as in claim 1 wherein the displacer is cylindrical and the working surface is the along the length of the cylinder and the shape of the end closest to the piston directs the flow of working fluid in manner supportive of the desired working fluid flow within the heat exchanger.

8. A device as in claim 1 wherein the displacer is cylindrical and regenerator material is attached to the displacer.

9. A device as in claim 1 wherein the displacer is cylindrical and a tube with regenerator material extends along the length of the displacer.

10. A device as in claim 1 wherein the displacer is cylindrical and attached to the displacer in the gap are various fins and equipment for monitoring and directing fluid flow.

11. A device as in claim 1 wherein the displacer is cylindrical and a fan blade extends along the length of the displacer for purpose of directing working fluid flow.

12. A device as in claim 1 wherein the displacer is cylindrical and its rotation is controlled by being mechanically attached to the crankshaft for the piston

13. A device as in claim 1 wherein the displacer is cylindrical and its rotation is controlled by external timing device or motor

14. A device as in claim 1 wherein the displacer is cylindrical and its rotation is controlled by magnetic coupling to a timing device.

15. A device as in claim 1 wherein the displacer is cylindrical and is composed partially or wholly of an insulating material.

16. A device as in claim 1 wherein the displacer is cylindrical and is a sealed vessel.

17. A device as in claim 1 wherein there are two displacers and two heat exchangers each coordinated with opposite sides of the piston.

18. A device as in claim 17 wherein there are two displacers and two heat exchangers each coordinated with opposite sides of the piston by means of a connecting rod that extends through the piston and forces counter rotation of each displacer.

19. A device as in claim 17 wherein there are two displacers and two heat exchangers each coordinated with opposite sides of the piston by means of two connecting rods each attached to opposite sides of the piston which allow coordinated yet same or opposite rotation of the displacers.

20. A device as in claim 17 wherein the connecting rod mounts within 1 inch of the center of the height of the piston

21. A device as in claim 18 wherein the connecting rod is sealed at its connection to the piston so as to not allow transfer of the working fluid during the active phase of the stroke.

22. A device as in claim 18 wherein the connecting rod extends through a piston pin which is mounted in the piston

23. A device as in claim 22 wherein a strategically placed hole in the piston pin serves as a valve to allow transfer of the working fluid at the extremes of the piston stroke by means of channels cut in the piston and the pin that align at the extremes of the piston stroke.

24. A device as in claim 17 wherein there is a means allowing transfer of the working fluid from one side of the piston to the other only at the extremes of the piston stroke.

25. A device as in claim 17 wherein the device is configured with one side converting heat differential, as from a heat source, into mechanical motion then used to power the other side used for converting mechanical motion into heat differential as might be used in refrigeration or distillation.

26. A device as in claim 1 wherein the piston cylinder encompasses part of the crankshaft.

27. A device as in claim 1 wherein the piston cylinder serves as support for the output shaft.

28. A device as in claim 1 wherein the displacer(s) are mounted at right angle to the piston cylinder.

29. A device as in claim 1 wherein regenerator material is located between the displacer and the piston

30. A device as in claim 17 wherein the displacers and displacer housings are parallel to each other and are mounted on the same side of the piston cylinder

31. A device as in claim 17 wherein the displacers and displacer housings are parallel to each other and mounted on opposite sides of the piston cylinder.

32. A device as in claim 17 wherein the displacers are not mounted parallel to each other

33. A device as in claim 1 wherein the heat dissipating radiator functions as a shrapnel catcher in the event of catastrophic failure of the pressurized heat exchanger.

34. A device as in claim 17 wherein the device provides power for electrical generation

35. A device as in claim 17 wherein the device provides power for use in an automobile

36. A device as in claim 17 wherein the device provides useable mechanical power.

37. A device as in claim 17 wherein the device is used on an aircraft.

38. A device as in claim 17 wherein the device is used in a structure or dwelling.

39. A device as in claim 17 wherein the device is used to convert sunlight to electricity

40. A device as in claim 17 wherein the device is used to convert fuel into electricity

41. A device as in claim 17 wherein the device is used on a watercraft of any kind

42. A device as in claim 17 wherein the device is used on a spacecraft

43. A device as in claim 1 wherein the piston consist of two identical discs fastened together

44. A device as in claim 17 wherein the device is attached to an alternator or generator which serves as a starter

45. A device as in claim 17 wherein the device is attached to an alternator or generator and the alternator or generator are in a pressurized container obviating the need for a seal on the output shaft.

46. A device as in claim 17 wherein their is a flywheel within the pressurized area.

47. A device as in claim 17 wherein their is a flywheel placed upon the output shaft.
